(19) United States
(12) Patent Application Publication
(10) Pub. No.: US 2015/0132682 A1
(43) Pub. Date: May 14, 2015

(54) MODEL-BASED ELECTROLYTE FILLING METHOD

(71) Applicant: Thomas Hecht, Dresden (DE)

(72) Inventor: Thomas Hecht, Dresden (DE)

(73) Assignee: Evonik Litarion GmbH, Kamenz (DE)

(21) Appl. No.: 14/397,573

(22) PCT Filed: Apr. 29, 2013
(86) PCT No.: PCT/EP2013/058859

§ 371 Date: Oct. 28, 2014

(30) Foreign Application Priority Data
May 16, 2012 (DE) 10 2012 208 222.0

(51) Int. Cl. H01G 11/04; H01M 2/36; C25B 9/08; H01M 10/02; H01M 8/02

(52) U.S. Cl. CPC H01G 11/04; H01M 10/02; H01M 8/02; C25B 9/08; H01M 2/361; H01M 2/362
USPC 429/498; 429/163; 204/252; 141/1.1; 141/32; 361/503

(57) ABSTRACT

The present invention relates to a method for producing an electrochemical cell, such as in particular a secondary battery, a double-layer capacitor, an electrolytic capacitor or a fuel cell, in which a cell vessel containing two electrodes of one-piece or multi-part design and at least one separator is filled with free-flowing electrolyte. The object of the invention is to match the quantity of electrolyte in an electrochemical cell as exactly as possible to the free volume actually present. The object is achieved in that, before the filling with the electrolyte, the quantity of electrolyte to be put in is determined at least while taking into account the actual thicknesses and the actual weights of the electrodes in the cell vessel and of the separator in the cell vessel. Furthermore, the invention relates to a method for producing a multiplicity of such electrochemical cells, an electrochemical cell which has been produced in accordance with the method, a plant for producing electrochemical cells, and the use of this plant for carrying out the method according to the invention.

The present invention relates to a method for producing an electrochemical cell, such as in particular a secondary battery, a double-layer capacitor, an electrolytic capacitor or a fuel cell, in which a cell vessel containing two electrodes of one-piece or multi-part design and at least one separator is filled with free-flowing electrolyte. Furthermore, the invention relates to a method for producing a multiplicity of such electrochemical cells, an electrochemical cell which has been produced in accordance with the method, a plant for producing electrochemical cells, and the use of this plant for carrying out the method according to the invention.

An electrochemical cell in the sense of this invention is a store for storing or for converting electrical energy by utilizing electrochemical effects. Electrochemical effects can be understood, for example, to mean transposition phenomena of ions, such as take place, for example, in secondary batteries (accumulators) or double-layer capacitors or electrolytic capacitors. Likewise, electrochemical effects can be understood to mean electrochemical reactions such as take place in the conversion of electrical energy into chemical energy or vice versa in fuel cells. For the implementation of the invention, the effects on the basis of which the energy is stored or converted in the electrochemical cell are unimportant. The decisive factor is that the electrochemical cell has two electrodes for producing the polarity and at least one separator for separating the electrodes, these elements being surrounded by electrolyte. The electrodes, the separator and the electrolyte are held in the cell vessel.

If, in the sense of this invention, mention is made of an electrode, the polarity of this electrode is not important. Anode and cathode are to the same extent electrodes in the sense of this invention. During the technical implementation of electrochemical cells, the electrodes are frequently implemented in many parts, which means that a plurality of components are joined together to form an electrode that is coherent when viewed electrochemically. This entirety is to be understood as an electrode in the sense of the invention. Accordingly, it is made clear in the claims that the electrode can be implemented in one piece or many parts.

The number of separators to be installed depends on the arrangement of the electrodes in the cell vessel. At least one separator must be provided, which separates the two electrodes from each other. If the electrodes are stacked or coiled, it may be necessary to arrange a plurality of separators between the subregions of the electrodes. For this reason, at least one separator is mentioned in the claims. The use of the singular separator is not intended to rule out the cell vessel according to the invention comprising a plurality of separators. Consequently, within the context of this invention, separator is also to be understood to mean the plural form. The separator is the electrochemically inactive component which separates the electrodes from one another in an electrically insulated manner but is permeable to the ions moving in the electrolyte.

For the invention, it is unimportant whether the electrodes are laid on one another flat, are stacked or coiled. These cell designs are known in the prior art. The design is not relevant to the invention.

However, the decisive factor is that at least one of the three fixed elements comprising cell, electrode, cathode, and separator is porous to a certain extent and the porosity fluctuates in the production process. In practice, both electrodes and the separator are porous and subject to fabrication-induced fluctuations.

Porosity is to be understood to mean that the volume calculated from the geometric external dimensions of the components does not coincide with the space actually enclosed by the material. Instead, the solid substances in the electrodes and in the separator enclose empty regions in the form of pores which, in the following text, are designated “free volume”. The free volume within the cell has to be filled with electrolyte in order to permit unimpeded exchange of the ions on the entire surface of the electrodes.

In order to achieve an optimal function and high performance, the free volume within the cell should be filled as completely as possible with electrolyte. Since the porosity of the components, and therefore the free volume within the cell, fluctuates as a result of the production, this means that the quantity of electrolyte optimally to be put in also fluctuates.

In the past history of battery production, such fluctuations of the free volume were hardly taken into account. Instead, a defined quantity of electrolyte was put into each cell, irrespective of how large the actual free volume turned out. This led to the filling level in the cell varying. In the case of comparatively rigid cell vessels, this presents barely any technical problems. However, fluctuating quantities of electrolyte affect the mechanical behaviour of electrochemical cells, the cell vessel of which is formed by a thin, flexible skin. For example, high-performance or high-energy-containing lithium-ion secondary batteries are nowadays readily implemented as “pouch cells”, as they are known. These are battery cells, the cell vessel of which is produced from aluminium foil and/or plastic film. Thin-skin pouch cells react to fluctuating quantities of electrolyte with changes in the overall space needed, which are obstructive in the highly concentrated assembly of battery modules. However, a greater problem consists in the fact that the dynamic natural frequency of oscillation of cells changes significantly as a result of different electrolyte filling quantities, since the damping provided by the electrolyte varies. When such electrochemical cells are used in mobile applications, such as in particular in vehicles driven by lithium-ion batteries, the changed oscillatory behaviour in the running operation leads to unpredictable ageing of the cells.

For this reason, there is a need to match the quantity of electrolyte in an electrochemical cell as exactly as possible to the free volume actually present. This is the object of the invention.

This object is achieved by a method of the generic type mentioned at the beginning in which, before the filling with the electrolyte, the quantity of electrolyte to be put in is determined at least while taking into account the actual thicknesses and the actual weights of the electrodes in the cell vessel and of the separator in the cell vessel.

Consequently, the subject matter of the invention is a method according to claim 1.

The invention is based on the finding that the actual thicknesses and the actual weights of the electrodes and separators in the cell vessel give the actual free volume within these porous components. Consequently, on the basis of a model-based estimate of the free volume, a filling quantity of electrolyte that is optimized to the individual case can be determined. Of course, this assumes that the relationship between thickness and weight of the components and the free volume resulting from this is known. This relationship can be determined simply in an experimental way for the cells to be fabricated with the aid of statistical methods. The values determined are then implemented in the technically performed process and used to predefine the quantity of electrolyte to be put in. In concrete terms, this means in practice that the values obtained from the experiment and the model resulting therefrom are programmed into a computer-controlled control device of the electrolyte filling plant. A measuring device measures the actual thicknesses and weights of the components used in the continuous process and forwards these measured values to the control device. The control device of the filling plant then uses the input variables in accordance with the model to calculate the optimal filling quantity of electrolyte and predefines this value to the filling device.

The quantity of electrolyte to be put in can optionally be determined via its volume or via its mass. In concrete terms, this means that the model determines the quantity of electrolyte as a volume in millilitres, for example, and the filling device provides a corresponding volume in millilitres of electrolyte and puts it into the cell vessel. This method is recommended when, in the case of liquid electrolytes, the volume can be measured easily and the volume does not change highly as a result of density fluctuations.

Alternatively, it is possible to determine the quantity of electrolyte to be put in from its mass (weight). Accordingly, the control device calculates a corresponding input weight of electrolyte, which is predefined to the filling device. The filling device weighs out a corresponding quantity of electrolyte and puts this into the cell vessel. The mass-based determination of the quantity of electrolyte is recommended in cases in which the density of the electrolyte is subject to fluctuations, for example when the liquid electrolyte expands or contracts under the influence of temperature or when a viscous gel electrolyte or solid body electrolyte is put in in particle form. In the case of such media, the volume cannot always be determined reliably, so that a weight-based determination of quantity is then recommended.

In principle, it is also possible to determine the quantity to be put in both via the volume and via the weight, in order in this way to compensate for measurement errors. As already mentioned, the determination of the free volume and therefore the electrolyte to be put in is carried out via a model. In this connection, model means that a mathematical formula for calculating the quantity of electrolyte is defined and is determined by parameters which, in actual fact, also influence the free volume within the cell. In this case, it should be noted that, in actual fact, the number of influencing factors is so large that it makes no sense to evaluate all of them and to incorporate them in the calculation. For this reason, models are always simplifying. A first simplification already takes place, according to the invention, in that only the thickness of the elements is used for the calculation of the free volume but not the two other geometric dimensions length and width. The restriction to the one geometric dimension has the basis that the coating thickness of electrodes or the layer thickness of separators in technically performed processes is subject to higher fluctuations than the length and width. This results from the fact that separators and electrodes are generally produced in a roll to roll process, in which variables in the machine direction and transversely thereto generally maintain narrower tolerances than layer thickness fluctuations. For this reason, according to the invention only the thickness of the components goes into the model, therefore substantially the coating thickness.

A further relevant simplification of the model consists in a linear formula being used to calculate the electrolyte to be put in, in which formula the sum of the thicknesses of the incorporated elements and the sum of the actual weights are used as variables. Such a linear formula has the general form

E=a*Σdᵢ+b*Σmᵢ+c [1]

In this formula, E represents the quantity of electrolyte to be put in (in particular volumetric and/or mass-based), Σdᵢ, as the sum of the actual thicknesses of the electrodes and separators in the cell vessel, Σmᵢ, as the sum of the actual weights of the electrodes and separators in the cell vessel, as linear variables and the fixed coefficients a, b, and c, which are determined experimentally and in the case of a and b represent real coefficients of first order for the sum of the thicknesses and the sum of the masses, respectively, and c represents the real coefficients of the zeroth order. Real coefficients in this connection means that the coefficients represent real numbers, which means that they can be positive, negative or zero, and also represent irrational fractions. a and b thus represent the two slopes of the linear relationship, c represents the intercept of the curve on the E axis.

This two-dimensional relationship permits a quite reliable determination of the quantity of electrolyte E to be put in in a relatively simple way while incorporating relatively few measured values (Σdᵢ and Σmᵢ).

According to the invention, two possible ways are suitable for determining the sum of the thicknesses Σdᵢ and the sum of the masses Σmᵢ. In a first variant, the summands dᵢ or mᵢ are measured individually, which means separately, and then the measured values are added up. The sum is thus formed mathematically from the individual measured values obtained physically. Alternatively, it is possible to form the sum physically, namely by assembling or stacking on one another and by physical measurement of the overall sum.

The mathematical summation is recommended when simple measured values are to be generated in the overall process; the other method when the measurement proves to be difficult. Ultimately decisive for the choice of the suitable measuring method is the nature of the substrates to be measured and the other conditions of the fabrication process of the electrochemical cells.

If the quantity E of the electrolyte to be put in is to be calculated from the total thickness d_{stack} and from the total mass m_{stack} of the electrodes in the cell vessel and of the separator in the cell vessel, this is done in accordance with the particularly simple linear formula [2]:

E=a*d_{stack}+b*m_{stack}+c [2]

where a and b represent real coefficients of first order for the total thickness d_{stack} and for the total mass m_{stack} of the electrodes in the cell vessel and of the separator in the cell vessel, and c represents the real coefficient of zeroth order.

In practice, the cell stack of electrodes and separators is not weighed individually but instead, as a rule, within the cell vessel and in combination with the conductors fixed to the electrodes. Since the weight of the cell vessel and of the conductors does not fluctuate so highly, both can be subtracted from the measured total weight of cell stack, cell vessel and conductors in order to reach the value m_{stack}.

Recommended as a particularly exact model for determining the quantity of electrolyte is a six-dimensional, linear equation of the form

E=aᵢ*d₁+a₂*d₂+a₃*d₃+b₁*m₁+b₂*m₂+b₃*m₃+c [3]

In this formula, E represents the quantity of electrolyte to be put in (in particular determined volumetrically and/or on a mass basis), d₁ the thickness of the first electrode, for example anode, d₂ the thickness of the second electrode, for example cathode, and d₃ the thickness of the separator. The coefficients a₁, a₂ and a₃ again represent real coefficients of first order for the respective thicknesses. In the same way, the coefficients b₁, b₂ and b₃ represent real coefficients of first order for the respective weights m₁, m₂ and m₃ of the first electrode, the second electrode and the separator. The real coefficient c is used as the E-axis intercept. As compared with the equation [1] quoted above, the present equation has a higher number of coefficients, which better represent the individual material properties of the two electrode types and the separator. If a plurality of separators is contained in the electrochemical cell, the thicknesses and weights of these separators can be determined individually and provided with individual coefficients. However, as a rule this will not be necessary, since the separator, differing from the electrodes, always consists of the same material, even if it is designed in many parts or is introduced in several layers.

The present invention is aimed at the industrial production of electrochemical cells in large numbers. In principle, it is desirable to add an individually determined quantity of electrolyte to each individual cell. However, particularly in large mass production runs, this would make no sense, since the fluctuation in the free volume within a production batch is not so large. Instead, it is advisable to define a specific number of operating cycles in a mass production process, within which all the cells are filled with an equal quantity of electrolyte, which has been determined from a reference cell within the production batch. As a result, the requirements on the dynamics of the electrolyte filling quantity determination are reduced, which increases the process reliability and reduces the investment costs.

The subject of a development of the invention is therefore a method for producing a multiplicity of electrochemical cells, in particular of secondary batteries, double-layer capacitors, electrolytic capacitors or fuel cells, having a number of operating cycles corresponding to the number of cells to be produced, in which, in each operating cycle, a cell vessel containing two electrodes of one-piece or multi-part design and at least one separator is filled with free-flowing electrolyte, a method according to the invention being carried out in a reference operating cycle in order to obtain a reference cell which is filled with a reference quantity of electrolyte and the remaining cell vessels being filled with the same reference quantity of electrolyte.

The number of operating cycles in turn depends on the fluctuations of the porosity within the process. The number of operating cycles, that is to say the number of cells which are filled with the same quantity of electrolyte on the basis of a reference quantity of electrolyte, is preferably limited to less than 10,000. The number of these operating cycles is preferably less than 1000 and quite particularly preferably less than 100. Instead of predefining the number of operating cycles fixedly, it is possible to predefine the number of operating cycles by means of an external event which exerts an influence on the porosity of the components used. In this case, it is possible not only to think primarily of process disruptions, but in particular of the complete consumption of a batch of material consumed in the method. As already mentioned, large industrial electrochemical cells are fabricated on the basis of electrodes and separators which are present via roll to roll processes as web products. These web products are generally supplied as a roll and introduced into the fabrication process of the cells. In the course of cell fabrication, the electrodes and separators are separated from the roll. In principle, it is to be expected that the porosity relationships within a roll (material batch) barely fluctuate, instead that the fluctuations occur only when the roll is changed. In this connection, it is advisable to fix the number of operating cycles to the number of cells to be produced from a roll. In this way, it is ensured that, after a new roll has been clamped in, a new reference cell is once more determined.

The subject of the invention is also an electrochemical cell, in particular a secondary battery, particularly preferably a lithium-ion secondary battery, a double-layer capacitor, an electrolytic capacitor or a fuel cell, comprising an electrolyte-tightly closed cell vessel, in which there are two electrodes of single-piece or multi-part design, at least one separator and electrolyte, the quantity of electrolyte in the cell vessel being determined by the actual thicknesses and the actual weights of the electrodes in the cell vessel and of the separator in the cell vessel. Such a cell is obtained by the method according to the invention being carried out. An electrochemical cell having these features, produced in accordance with the method according to the invention, is thus likewise a subject of the invention.

A further subject of the invention is a plant for the production of electrochemical cells, in particular for the production of secondary batteries, double-layer capacitors, electrolytic capacitors or fuel cells, which comprises the following features:
a) means for providing electrodes and separators;
b) measuring devices generating measured values for measuring thickness and weight of electrodes and separators provided;
c) a computing device for calculating a quantity of electrolyte from the measured values generated by the measuring device;
d) means for providing cell vessels;
e) means for placing electrodes and separators in cell vessels;
f) means for providing electrolyte in the quantity of electrolyte calculated by the computing device;
g) means for putting the quantity of electrolyte provided into cell vessels provided.

Only the essential features of this plant are enumerated; of course the plant for carrying out the method according to the invention can also comprise further components. The plant according to the invention can optionally relate only to the filling area of cell production or else comprise preceding and/or subsequent production sections of the production method for cells.

Finally, a subject of the invention is also the use of such a plant for producing electrochemical cells of the type according to the invention in accordance with a method according to the invention.

### EXAMPLE

The present invention is now to be explained in more detail by using an example. For this purpose:

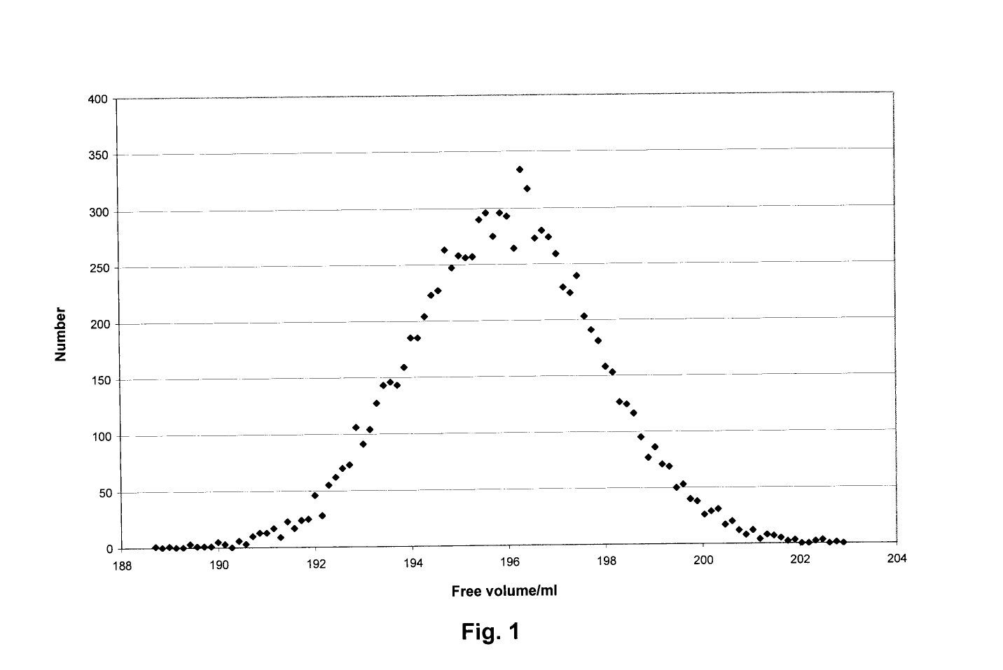

FIG. 1: shows the distribution of magnitudes of the actual free volume in a production batch (histogram);

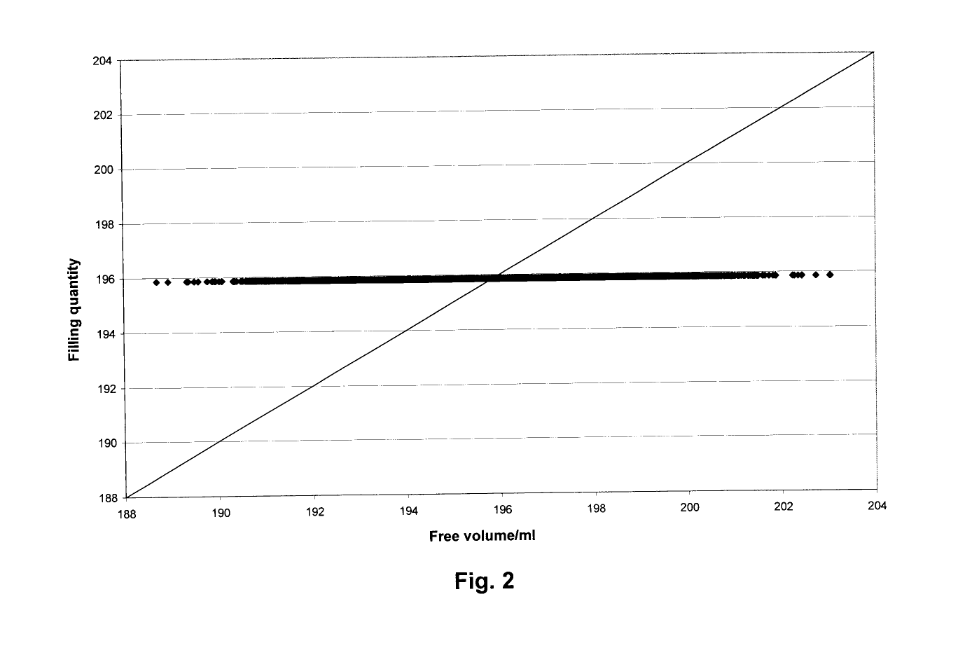

FIG. 2: shows a graph relating to the comparison of the deviation of the constant filling quantity from the actual free volume (prior art);

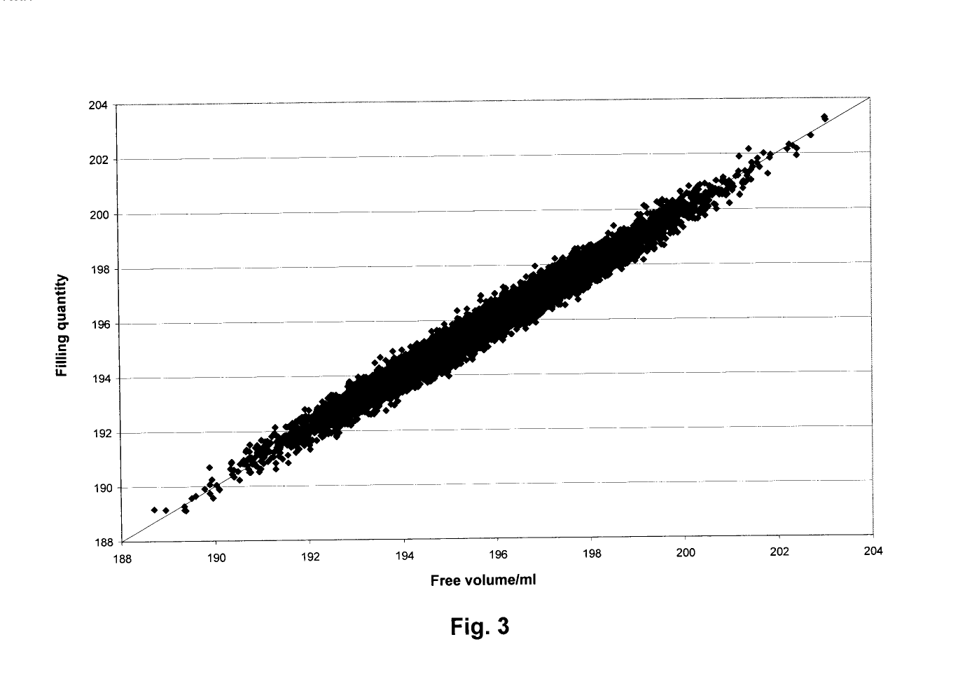

FIG. 3: shows a graph relating to the comparison of the deviation of the filling quantity determined in accordance with the model from the actual free volume (according to the invention).

The application of the electrolyte filling method according to the invention and the associated model building is to be illustrated by using a lithium-ion battery cell. A lithium-ion battery cell (secondary battery/accumulator) comprises the following functional components: an anode, a cathode, a separator which isolates anode and cathode from each other, electrolyte, in which the electrodes and the separator are immersed. The electrodes, the separator and the electrolyte are accommodated in a cell vessel. The cell vessel is closed in order to avoid loss of the electrolyte and to protect the components against any chemical influence. Terminals, which are connected to the anode and cathode, project out of the cell vessel. Via the terminals, electrical voltage is applied or removed and, in this way, electrical energy is stored in the cell or retrieved therefrom.

In the industrial design of such a lithium-ion battery cell, the electrodes are implemented as layer components. They comprise an electrochemically passive carrier foil which is coated with an electrochemically active material. The anode is built up on copper foil, which is coated with graphite as active material. In addition to graphite, the active material of the anode also contains conductive carbon black and a binder. The active material of the anode is porous in order to achieve a large surface, which adds to the power capacity of the cell. On the other hand, the copper foil of the anode is solid.

The cathode is based on an aluminium foil which is coated with a metal mixed oxide. The metal mixed oxide is likewise bound to itself and to the foil via a binder, and conductive carbon black serves as an additive. Suitable as the mixed metal oxide are, for example, nickel oxides, manganese oxides, cobalt oxides. The cathode coating is likewise porous, the aluminium foil solid.

The invention can be applied irrespective of the active materials used. The prior art knows a multiplicity of different pairings of materials from which a lithium-ion battery cell can be built up. An overview is given by:
Van Schalkwijk, Walter; Scrosati, Bruno: Advances in Lithium-Ion Batteries. 2002, 1-5, DOI: 10.1007/0-306-47508-1_{—}1

Coated or uncoated polymer films, nonwovens or thin-layer ceramic components can be used as a separator. Organic/inorganic composite materials are preferably used as a separator, for example based on an organic nonwoven which is provided with an inorganic coating. Separators of this type likewise have a certain porosity in order to absorb electrolyte.

The anode and the cathode, separated by the separator, are inserted into the cell vessel, for example in the form of a plastic-coated aluminium foil, which is filled with electrolyte and closed. Here, reference is made to the general prior art.

Suitable as the electrolyte are lithium salts which are dissolved in an organic solvent or an ionic liquid. Here, too, reference is made to the general prior art.

In order to utilize the overall space of the cell particularly well, the electrochemically functional electrodes are of multi-part design: for example, the anode consists of a multiplicity of individual anodes which are connected electrically to one another. The cathode also consists of a multiplicity of individual cathodes which are connected to one another. In each case a separator is inserted between the individual constituent parts of the electrodes. This means that, in a cell vessel, in addition to the liquid electrolyte there is a multiplicity of individual porous components which, viewed functionally/electrochemically, however, represent only the three elements anode, cathode and separator.

Table 1 shows the parameters of the components of the cells produced in accordance with the invention.

TABLE 1
Parameters of the components of the cells produced

| Variable | Unit | Value |
|---|---|---|
| Number of anode parts | — | 25 |
| Number of cathode parts | — | 24 |
| Number of separator pieces | — | 50 |
| Total area of anode | m² | 0.052 |
| Total area of cathode | m² | 0.05 |
| Total area of separator | m² | 0.054 |
| Solid density of anode material | g/m³ | 2.0 |
| Solid density of cathode material | g/m³ | 4.1 |
| Solid density of separator | g/m³ | 3.4 |
| Thickness of Cu foil (anode) | μm | 10 |
| Thickness of Al foil (cathode) | μm | 15 |
| Intended layer thickness of anode | μm | 170 |
| Intended layer thickness of cathode | μm | 170 |
| Intended thickness of separator | μm | 30 |
| Intended wt/unit area of anode without foil | g/m² | 220 |
| Intended wt/unit area of cathode without foil | g/m² | 370 |
| Intended wt/unit area of separator | g/m² | 35 |
| Weight/unit area of Cu | g/m² | 89 |
| Weight/unit area of Al | g/m² | 41 |

As can be gathered from Table 1, the cathode, viewed electrochemically, is built up from 24 individual cathode parts. The anode, viewed electrochemically, consists of 25 individual anode parts. In each case a separator piece is inserted between these individual parts, so that a total of 50 separator pieces are installed. The cell vessel thus contains 99 porous components and liquid electrolyte.

The values of the thicknesses and of the weights per unit area are statistically normally distributed. The standard deviation for thicknesses and weights per unit area of the electrodes is 0.5% of the intended value. The standard deviation for thicknesses and weights per unit area of the separator is 1.0% of the intended value. This means that the coating thicknesses of the electrodes fluctuate about their intended value of 170 μm by ±0.5% (standard deviation 1σ) as a result of production. The weights per unit area of anode (220 g/m²) and cathode (370 g/m²) likewise fluctuate by ±0.5%. The remaining values are assumed to be constant. The intended thickness of the separator of 30 μm is likewise subject to a standard deviation, which lies in the region of ±1%. The intended weight per unit area of the separator (35 g/m²) likewise fluctuates by ±1% as a result of production. The remaining measured values of the separator are assumed to be constant.

A graphical representation of the free volumes of the production batch considered is shown by FIG. 1. The normal distribution (Gaussian bell) can be seen clearly in the histogram.

Because of the production-induced fluctuations in the coating thicknesses and weights per unit area, fluctuations occur in the porosity of the individual components and therefore in the free volume of the cell which is to be filled by electrolyte. The fluctuations of the free volume and therefore of the intended filling quantity are of the order of magnitude of 1% (standard deviation 1σ).

With the aid of statistical methods, namely linear regression, the coefficients a and b of the linear equation [1] are calculated from the normally distributed values. The mathematical basis needed for this purpose will be found in:
Storm, Regina: Wahrscheinlichkeitsrechnung, mathematische Statistik and statistische Qualitätskontrolle [Probability calculation, mathematical statistics and statistical quality control], 11th edition 2001, Munich; Vienna: Fachbuchverlag Leipzig im Carl-Hanser-Verlag ISBN 3-446-21812-2.

The coefficient of zeroth order c can also be determined mathematically in accordance with linear regression. However, it is advantageous in practical operation to put in more electrolyte than necessary to fill the free volume, for example because electrolyte can be consumed or broken down during the operation of the accumulator. In order to compensate for this, c is chosen to be somewhat higher than mathematically calculated. In order to obtain an optimal value for c, c is varied in practical trials and the cells obtained are assessed with regard to their appearance, damping and electrochemical properties. This then yields the optimum value for the constant coefficient c.

For the trial quantity of battery cells illustrated in FIG. 1, the coefficients for the linear model are given in accordance with Table 2.

TABLE 2
Coefficients calculated from the model

| Coefficient | Variable | Unit | Value |
|---|---|---|---|
| a | Cell thickness | ml/mm | 51.6616 |
| b | Cell weight | ml/g | −0.3166 |
| c | Constant | ml | 1.3847 |

These values are then inserted into Equation [1] in order thus to reach a concrete, linear regression equation [4].

Equation 4: Result of the regression

E[ml]=51.6616*Σdᵢ [mm]−0.3166*Σmᵢ[g]+1.3847 [4]

The linear coefficient c here has been determined exclusively mathematically from the regression. Therefore, the free volume is filled completely. If, in practice, a further electrolyte excess is desired, then this can be determined as described above.

With the aid of this equation, the optimal filling quantity E of electrolyte can then be determined.

For this purpose, the sum of the thicknesses of the electrodes and of the separator Σdᵢ is measured and also the total weight of the electrodes and separators Σmᵢ in the cell vessel. The thickness measurement can be carried out, for example, opto-electronically, in particular by laser triangulation. If the component stack is soft, it is recommended during the thickness measurement to clamp in between two plane-parallel plates under a defined force and then to measure the spacing of the plates. In this way, deformation-induced erroneous measurements are avoided. The sum of the masses Σmᵢ is determined by weighing. It is optionally possible to record the sum of the thicknesses in a single measurement, by the stack of electrodes and separators being measured in its entirety. Alternatively, the thicknesses of the electrodes and separators can be measured individually and added up mathematically. In the same way, either the entire pack of electrodes and separators can be weighed or else the electrodes and separators are weighed individually and the sum of the weights from the measured values is added. Inserted into Equation [4], these values result in an optimized electrolyte filling quantity E, volumetrically in millilitres, which takes account of the actual thicknesses and weights of the electrodes and separators inserted into the cell vessel.

FIGS. 2 and 3 each show a graph in which the filling quantity E is plotted against the actual free volume. Ideal is a ratio of 1:1, illustrated by the straight line which runs at an angle of 45° through the point of intersection of the two axes.

The set of points distributed horizontally in FIG. 2 relates to a fixed quantity of electrolyte of 196 ml according to the prior art. In the area of an actual free volume of 196 ml there is agreement but, towards the edge regions, the error becomes very large.

By contrast, the set of points running diagonally in FIG. 3 is determined on the basis of a model in accordance with Equation [4]. Each point represents a calculated quantity of electrolyte, starting from the statistically distributed values for the actual thickness and weights of the cell components. It can be seen that the deviation of the filling quantity from the actual free volume is subject to only a small error over wide areas of the varied free volume.

Theoretically, it is possible to improve the set of points of the model-based calculation of the quantity of electrolyte further by more parameters being used in the calculation of the model, for example in accordance with Equation [3]. As a result, the points of the set of points move closer to the ideal diagonal. However, the increased number of parameters increases the effort to reach this result. As a rule, this will not be economically tolerable. The linear model presented to this extent constitutes an excellent compromise between costs and quality improvement.

The comparison of FIGS. 2 and 3 shows that the filling errors, that is to say the distance from the respective point to the ideal diagonal, turns out to be considerably lower in the model-based system (FIG. 3) than when the constant filling quantity (FIG. 2) is used.

1. A method for producing an electrochemical cell, comprising
filling a cell vessel comprising two electrodes of one-piece or multi-part design and a separator with free-flowing electrolyte,
wherein, before filling with the electrolyte, a quantity of electrolyte to be in added is determined while taking into account an actual thickness and an actual weight of the electrodes in the cell vessel and of the separator in the cell vessel.

2. The method according to claim 1, wherein the quantity of electrolyte to be added is determined via its weight, volume, or both.

3. The method according to claim 1, wherein the quantity E of electrolyte to be added is calculated from a sum of the actual thicknesses Σdᵢ and a sum of the actual weights Σmᵢ of the electrodes in the cell vessel and of the separator in the cell vessel in accordance with the linear formula [1]:
E=a*Σdᵢ+b*Σmᵢ+c [1]
wherein a and b represent real coefficients of first order for the sum of the thicknesses Σdᵢ and for the sum of the masses Σmᵢ, and c represents a real coefficient of zeroth order.

4. The method according to claim 3, wherein a summand dᵢ, mᵢ, or both are measured individually and then the measured values are added to form the sum Σdᵢ of the thicknesses and the sum Σmᵢ of the masses, respectively.

5. The method according to claim 3, wherein the sum of the thicknesses Σdᵢ, the sum of the masses 93 mᵢ, or both are measured as a total thickness d_{stack} or total mass m_{stack}.

6. The method according to claim 5, wherein the quantity E of the electrolyte to be added is calculated from the total thickness d_{stack} and from the total mass m_{stack} of the electrodes in the cell vessel and of the separator in the cell vessel in accordance with the linear formula [2]:
E=a*d_{stack}+b*m_{stack}+c [2]
wherein a and b represent real coefficients of first order for the total thickness d_{stack} and for the total mass m_{stack} of the electrodes in the cell vessel and of the separator in the cell vessel, and c represents the real coefficient of zeroth order.

7. The method according to claim 1, wherein the quantity E of the electrolyte to be added is calculated from an actual thickness d₁, d₂ and d₃ and an actual weight m₁, m₂ and m₃ of the electrodes in the cell vessel and of the separator in the cell vessel in accordance with the linear formula [3]:
E=a₁*d₁+a₂*d₂+a₃*d₃+b₁*m₁+b₂m₂+b₃*m₃+c [3]
wherein aᵢ represents real coefficients of first order for the respective thickness of the first electrode d₁, of the second electrode d₂ and of the separator d₃ and bᵢ represents real coefficients of first order for the respective mass of the first electrode m₁, of the second electrode m₂ and of the separator m₃, and c represents the real coefficient of zeroth order.

8. A method for producing a multiplicity of electrochemical cells having a number of operating cycles corresponding to the number of cells to be produced, the method comprising in each operating cycle,
filling a cell vessel comprising two electrodes of one-piece or multi-part design and a separator with free-flowing electrolyte, wherein the method according to claim 1 is carried out in a reference operating cycle to obtain a reference cell which is filled with a reference quantity of electrolyte, and the remaining cell vessels are filled with the same reference quantity of electrolyte.

9. The method according to claim 8, wherein the number of operating cycles is less than 10,000, or the number of operating cycles being predefined by an event.

10. An electrochemical cell, comprising
an electrolyte-tightly closed cell vessel comprising two electrodes of single-piece or multi-part design, a separator and an electrolyte,
wherein a quantity of electrolyte in the cell vessel is determined by an actual thickness and an actual weight of the electrodes in the cell vessel and of the separator in the cell vessel.

11. A plant for the production of an electrochemical cell comprising:
a) an electrode and a separator;
b) a measuring device, which measures a thickness and a weight of the electrode and separator;
c) a computing device, which calculates a quantity of electrolyte from the measured values generated by the measuring device;
d) a cell vessel;
e) a placing device, which places the electrode and separator in the cell vessel;
f) an adding device, which provides electrolyte in the quantity calculated by the computing device and adds the quantity of electrolyte into the cell vessel.

12. (canceled)

13. The method according to claim 1, wherein the electrochemical cell is a secondary battery, a double-layer capacitor, an electrolytic capacitor or a fuel cell.
